(19) United States
(12) Patent Application Publication
(10) Pub. No.: US 2016/0078323 A1
(43) Pub. Date: Mar. 17, 2016

(54) METHOD AND APPARATUS FOR COUNTING PERSON

(71) Applicant: SAMSUNG ELECTRONICS CO., LTD., Suwon-si (KR)

(72) Inventors: Teshome MIKIYAS, Suwon-si (KR); Ho-yub JUNG, Suwon-si (KR)

(21) Appl. No.: 14/855,682

(22) Filed: Sep. 16, 2015

(30) Foreign Application Priority Data
Sep. 17, 2014 (KR) 10-2014-0123729

(51) Int. Cl. G06K 9/62; G06T 7/00; G06T 7/20

(52) U.S. Cl. CPC G06K 9/6282; G06T 7/2033; G06T 7/0048

(57) ABSTRACT

A counting method and apparatus are provided. The method and/or apparatus includes generating a regression tree by inputting information about a moving object contained in a plurality of images, in response to a new image being input, inputting information about a moving object contained in the new input image to the regression tree, and determining the number of people contained in the new image based on a result value of the regression tree.

### CROSS-REFERENCE TO RELATED APPLICATIONS

This application is based on and claims priority under 35 U.S.C. Section 119 to Korean Patent Application No. 10-2014-0123729, filed on Sep. 17, 2014, in the Korean Intellectual Property Office, the disclosure of which is incorporated herein by reference in its entirety.

### BACKGROUND

1. Field

Apparatuses and methods consistent with what is disclosed herein relate to a counting method, and to a counting apparatus, for counting a plurality of people contained in an image with rapid and simple computation.

2. Description of Related Art

Technologies for counting the number of people contained in a video image may be variously used for crime prevention or marketing. For example, an image captured by a closed circuit television (CCTV) installed at an entrance of a department store may be analyzed to count and track the number of people who enter or leave the department store.

An example of a prior art includes a technology for detecting and tracking people contained in an image. According to this technology, pixel values of a plurality of consecutive image frames are compared to separately detect and track people according to feature values. However, the technology is disadvantageous in that pixels of all image frames need to be compared to require complicated computation. In particular, when there are a lot of people, the people need to be separately detected and tracked to increase computation amount, and thus high performance hardware is required.

As another method, the number of people may be counted using movement flow of the people. A method for estimating people flow and counting people is advantageous in terms of simple computation. However, when there is a plurality of people, it is difficult to separately track the people. In addition, the same person may be redundantly counted.

Accordingly, there is a need for a technology for counting a plurality of people contained in an image with rapid and simple computation.

### SUMMARY

Example embodiments overcome the above disadvantages and other disadvantages not described above. Also, example embodiments need not be required to overcome the disadvantages described above, and example embodiments may not overcome any of the problems described above.

Example embodiments provide a method and apparatus for counting a plurality of people contained in an image with rapid and simple computation.

According to certain example embodiments, a counting method includes generating a regression tree by inputting information about a moving object contained in a plurality of images, in response to a new image being input, inputting information about a moving object contained in the new input image to the regression tree, and determining the number of people contained in the new image based on a result value of the regression tree.

The generating of the regression tree may include identifying a movement pixel using a difference value between pixels corresponding to two or more images, receiving information about the movement pixel from an outside, and generating the regression tree by classifying the external input information according to a preset parameter.

The information about the movement pixel may include at least one of information about whether the movement pixel indicates a person and positional information about the movement pixel.

The generating of the regression tree classifying the external input information according to the preset parameter may include generating the regression tree by disposing nodes having the external input information according to a first parameter, and reconfiguring the regression tree according to a second parameter different from the first parameter when external input information items of a leaf node of the first regression tree are not similar.

The inputting of the information about the moving object contained in the new input image to the regression tree may include, in response to a plurality of new images being input, identifying a movement pixel using a difference value between pixels corresponding to the plurality of new input images, and inputting information about the identified movement pixel to the regression tree.

The information about the identified movement pixel may include positional information of the identified movement pixel.

The determining of the number of the people may include determining whether the moving object contained in the new input image is a person based on the result value of the regression tree, and when the moving object is a person, counting the people when the moving object passes through a preset position on an image.

The counting method may further include consecutively capturing the plurality of images.

According to certain example embodiments, a counting apparatus includes a regression tree generator and a counter.

The regression tree generator is configured to generate a regression tree by inputting information about a moving object contained in a plurality of images.

The counter, in response to a new image being input, inputs information about a moving object contained in the new input image to the regression tree and determines the number of people contained in the new image based on a result value of the regression tree.

The regression tree generator may identify a movement pixel using a difference value between pixels corresponding to two or more image and, in response to information about the movement pixel being input from an outside, generate the regression tree by classifying the external input information according to a preset parameter.

The information about the movement pixel may include at least one of information about whether the movement pixel indicates a person and positional information about the movement pixel.

The regression tree generator may generate the regression tree by disposing nodes having the external input information according to a first parameter and reconfigure the regression tree according to a second parameter different from the first parameter when external input information items of a leaf node of the first regression tree are not similar.

The counter, in response to a plurality of new images being input, may identify a movement pixel using a difference value between pixels corresponding to the plurality of new input images, and input information about the identified movement pixel to the regression tree.

The information about the identified movement pixel may include positional information of the identified movement pixel.

The counter may determine whether the moving object contained in the new input image is a person based on the result value of the regression tree, and when the moving object is a person, the counter may count the people when the moving object passes through a preset position on an image.

According to various embodiments, a counting method and a counting apparatus may count a plurality of people contained in an image with rapid and simple computation.

Additional and/or other aspects and advantages will be set forth in part in the description which follows and, in part, will be obvious from the description, or may be learned by practice of example embodiments.

### BRIEF DESCRIPTION OF THE DRAWING FIGURES

The above and/or other aspects will be more apparent by describing certain example embodiments with reference to the accompanying drawings, in which:

FIGS. 1 and 2 are diagrams for explanation of a technology for counting people contained in an image according to prior art;

FIGS. 3 and 4 are flowcharts of a counting method according to various example embodiments;

FIG. 5 is a diagram illustrating a motion history image according to an example embodiment;

FIG. 6 is a diagram illustrating a regression tree according to an example embodiment;

FIG. 7 is a flowchart of a method for inputting information about a moving object of a new input image to a regression tree to travel the regression tree;

FIG. 8 is a flowchart illustrating a procedure for determining the number of people according to an embodiment; and

FIG. 9 is a block diagram illustrating a counting apparatus according to an embodiment.

### DETAILED DESCRIPTION

Hereinafter, certain example embodiments will be described in detail with reference to the attached drawings.

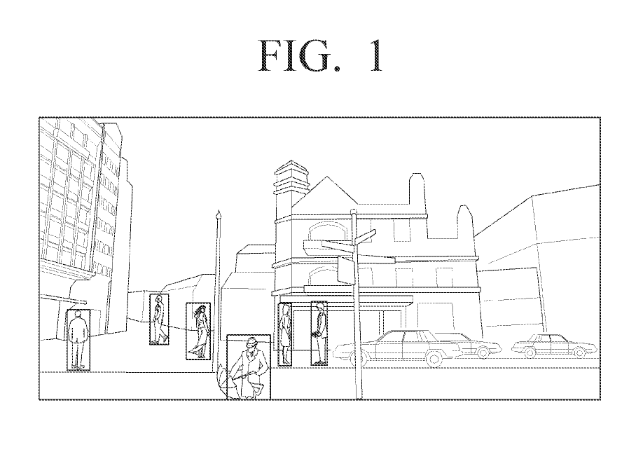

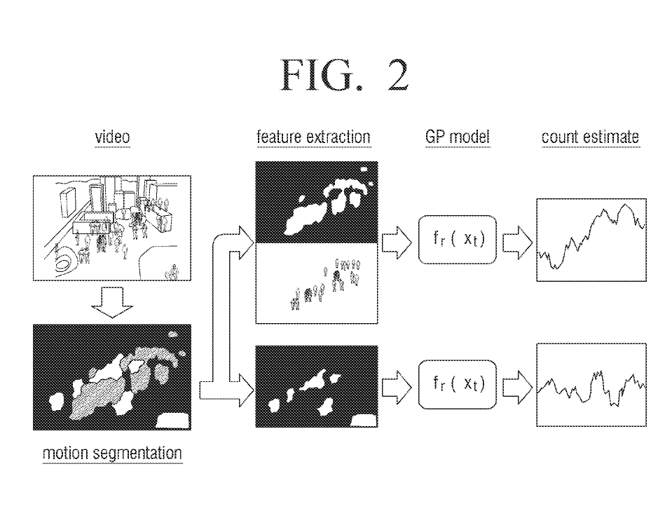

FIGS. 1 and 2 are diagrams for explanation of a technology for counting people contained in an image according to prior art.

FIG. 1 is a diagram illustrating a technology for separately detecting and tracking people contained in an image. According to the technology, people are detected from consecutive image frames and feature values of the respective image frames are compared. When the same object (e.g., person) is present on or in a plurality of images, the object is considered as one person. However, as described above, the technology is disadvantageous in that pixels of all image frames need to be compared and require complicated computation. In particular, when there are many people, the people need to be separately detected and tracked which increases computation amount, and thus high performance hardware is required.

FIG. 2 is a diagram illustrating a method for computing people flow and counting the people. During the computation, continuous areas with similar pixel values are contained in one flow. Accordingly, a plurality of flows may be acquired and the flows may be interpreted as a movement trajectory of the same person. One independent flow may be computed as a plurality of people according to amplitude of the flow. As described above, the method for estimating people flow and counting people is advantageous in terms of simple computation. However, when there is a plurality of people, it is difficult to separately track the people. In addition, the same person may be redundantly counted.

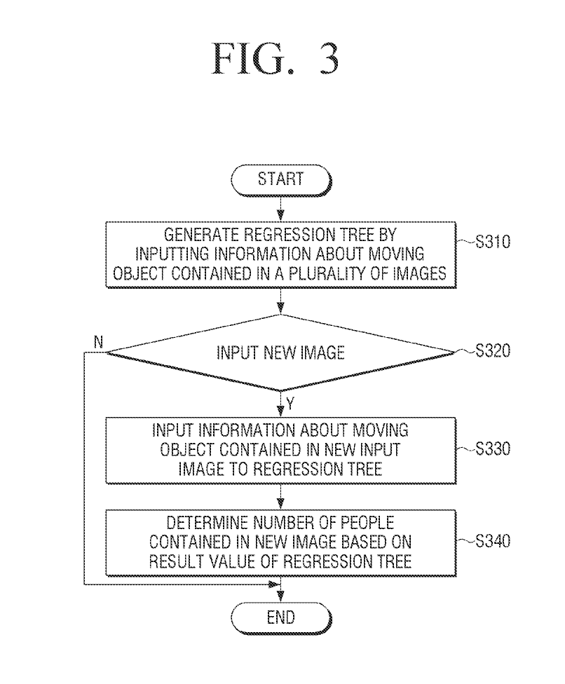

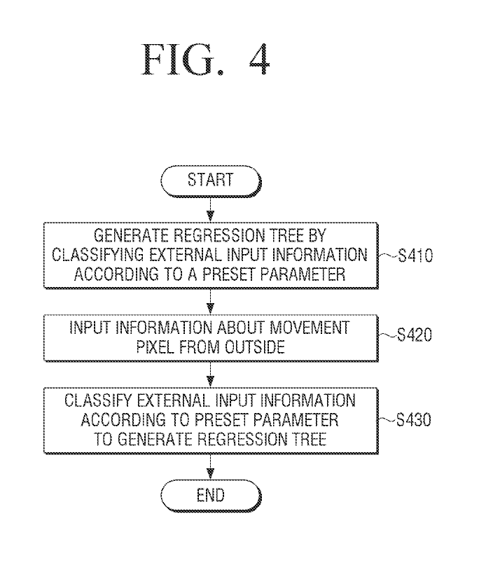

FIGS. 3 and 4 are flowcharts of a counting method according to example embodiments herein.

Referring to FIG. 3, in a counting method according to an embodiment, first, a regression tree is generated (S310). In general, regression analysis refers to a method for extracting an optimum or otherwise sufficient or best formula for expressing given data. The regression tree is configured as an optimum tree for expressing given data while changing a parameter. Since the current operation may be performed for extracting an optimum regression tree, the operation may be referred to as a training operation. When new data is given, attribute of the new data may be predicted through a result value of the regression tree.

According to an embodiment, information about a moving object (e.g., person(s)) contained in a plurality of consecutive image frames constituting a video image is input to generate the regression tree. The best, or an otherwise sufficient, regression tree for expressing the information about the moving object in the consecutive image frames is configured, which will be described in more detail.

When the regression tree is configured and then a new image is input (S320-Y), the regression tree is traversed based on information about the image. In detail, the information about the moving object(s) contained in the input new image is input to the regression tree (S330).

According to the traversal result of the regression tree, that is, values of lead nodes, the attribute of the moving object contained in the new image is determined. The number of people contained in the new image may be determined based on the result value of the regression tree (S340), which will be described below in more detail.

FIG. 4 is a diagram illustrating a method for acquiring a motion history image in order to generate a regression tree.

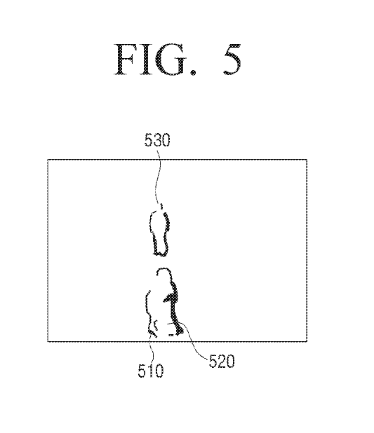

The motion history image is an image generated by identifying a moving object contained in a plurality of consecutive image frames. In order to identify the moving object contained in the image frames, a difference value between pixels corresponding to two or more consecutive images is determined (S410). A region with a difference value may be considered as a region in which an object moves. A region in which an object moves such that a pixel value is changed is processed with black. The remaining region may be processed with white. When the aforementioned operations are performed on the moving object contained in the image, a motion history image illustrated in FIG. 5 may be obtained. FIG. 5 is a diagram illustrating a motion history image according to an example embodiment.

In an operation for configuring a regression tree, information about a moving object contained in the motion history image is received (S420). That is, when information about a movement pixel is input, the information about the movement pixel may include at least one of information about whether the movement pixel indicates a person, probability information of the movement pixel, and positional information about the movement pixel. The positional information of the movement pixel may be determined using coordinate information without external input. As a result, the information about whether the movement pixel indicates a person and the positional information about the movement pixel are stored with respect to all movement pixels of the motion history image. The probability information of the movement pixel may be information indicating probability that the movement pixel is present in the moving object. For example, when a moving object is configured with 500 pixels, one movement pixel has a probability of 1/500. One movement pixel constitutes a minimum unit of a moving object, and thus the term ‘proportionality’ may be used instead of the term ‘probability’.

The regression tree is written using the movement pixel. That is, the external input information is classified according to a preset parameter to generate the regression tree (S430).

In this case, the generating of the regression tree by classifying the external input information according to the preset parameter may include disposing a node having the external input information according to a first parameter to generate the regression tree, and reconfiguring the regression tree according to a second parameter different from the first parameter when external input information items of leaf nodes of the generated regression tree are not similar. That is, an optimum regression tree is configured while changing a parameter.

According to an embodiment, two adjacent pixels of a movement pixel may be randomly selected. In addition, distances with a target pixel are computed. When a distance difference between the two random pixels and the target pixel is less than a preset value, a left link or branch of the tree is traversed/traveled. On the other hand, when the distance difference between the two random pixels and the target pixel is equal to or greater than a preset value, a right link or branch of the tree is traversed/traveled. The determined regression tree is examined. Leaf nodes of the regression tree may include information about a plurality of movement pixels, and information about the plurality of movement pixels needs to be similar. For example, when a pixel about a person is exceptionally contained in a movement pixel group (information about a leaf node) and this error is determined to be significant, a regression tree can be be reconfigured. The regression tree is reconfigured by adjusting a parameter value. Until a regression tree that satisfies a preset error rate is determined, the above procedure is repeatedly performed.

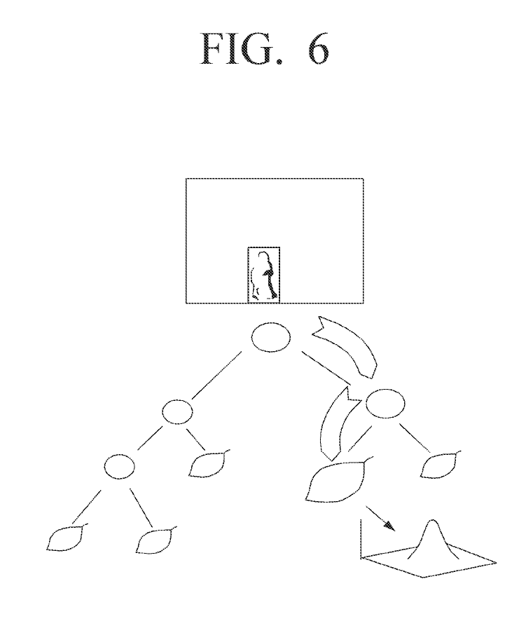

FIG. 6 is a diagram illustrating a regression tree according to an embodiment.

As illustrated in FIG. 6, the regression tree is generated using input information with respect to a movement pixel. A specific leaf node includes dominant attribute information of a pixel group.

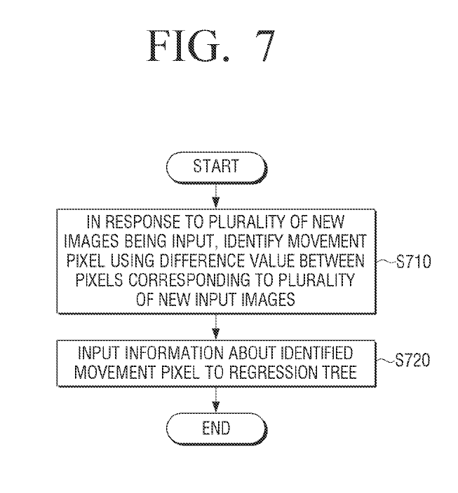

FIG. 7 is a flowchart of a method for inputting information about a moving object of a new input image to a regression tree to travel or traverse the regression tree.

As illustrated in FIG. 7, in the inputting of the information about the moving object contained in the new input image to the regression tree, when a plurality of new consecutive new images is input, a movement pixel is identified using a difference value between pixels corresponding to the plurality of new input images (S710).

Information about the identified movement pixel is input to the regression tree (S720).

This procedure is the same as the aforementioned procedure of generating the motion history image. That is, the motion history image is generated with respect to a new input image. In detail, a difference value between pixels corresponding to two or more consecutive images is determined A region with a difference value may be considered as a region in which an object moves. A region in which an object moves such that a pixel value is changed is processed with black. The remaining region may be processed with white. The above procedure is performed on all moving objects contained in the image.

Basically, a moving object has positional information. Thus, positional information of a movement pixel constituting a moving object may be input to the regression tree to travel the regression tree. A leaf node as a travel result of the regression tree indicates attribute of the movement pixel. That is, the leaf node indicates a probability value of the movement pixel, whether the movement pixel indicates a person, and so on. The travelling/traversing of the regression tree may be performed with log N assuming that N nodes are present, and thus the attribute of the movement pixel may be very rapidly recognized.

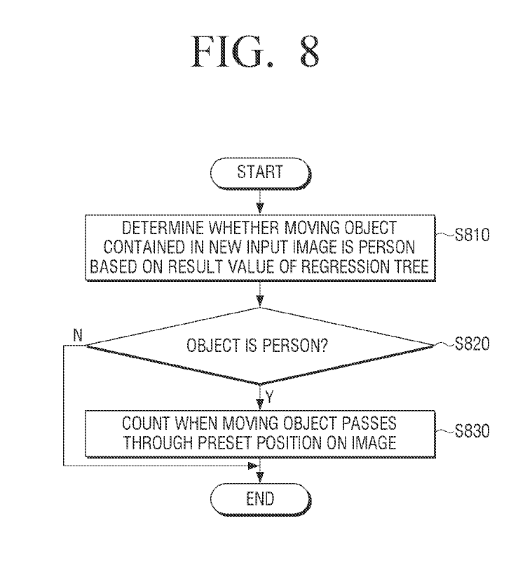

FIG. 8 is a flowchart illustrating a procedure for determining the number of people according to an embodiment.

Referring to FIG. 8, the determining of the number of people includes determining whether a moving object contained in the new input image is a person based on a result value of the regression tree (S810), and when the moving object is a person (S820-Y), counting the moving object if the moving object passes through a preset position on an image (S830).

As described above, when the regression tree is traveled/traversed, the attribute of the moving pixel is recognized. A leaf node indicates whether a moving object containing a movement pixel is a person and a probability that the movement pixel is present.

When it is determined that the moving object is a person, it may possibly be inefficient in some instances to determine a moving object in an entire region of an image. Accordingly, when the moving object (e.g., person) passes through a preset position of the image, the moving object may be counted. Values obtained by adding multiplied values of probabilities of movement pixels and 1 are 1, and thus the counting of the moving object may be easily computed as one person. On the other hand, when the moving object passes through an imaginary line of the image, the number of people may be counted. Alternatively, an interest area may be drawn and the number of people that enter the interest area may be counted.

The aforementioned counting method may have an advantage of rapidly determining the number of moving people contained in an image using a regression tree.

A non-transitory computer readable medium may store thereon a program for performing the aforementioned counting method. The non-transitory computer readable medium is a medium that semi-permanently stores data and from which data is readable by a device, but not a medium that stores data for a short time, such as register, a cache, a memory, and the like. For example, the non-transitory computer readable medium may include a compact disc (CD), a digital versatile disc (DVD), a hard disc, a bluray disc, a universal serial bus (USB), a memory card, a read only memory (ROM), and the like. In addition, the aforementioned counting method may be installed and provided in a hardware integrated circuit (IC) chip in the form of embedded software. It will be appreciated by those skilled in the art that the described systems, methods and techniques may be implemented in digital electronic circuitry including, for example, electrical circuitry, logic circuitry, hardware, computer hardware, firmware, software, or any combinations of these elements. Apparatus embodying these techniques may include appropriate input and output devices, a computer processor, and a computer program product tangibly embodied in a non-transitory machine-readable storage device or medium for execution by a programmable processor. A process embodying these techniques may be performed by a programmable hardware processor executing a suitable program of instructions to perform desired functions by operating on input data and generating appropriate output. The techniques may be implemented in one or more computer programs that are executable on a programmable processing system including at least one programmable processor coupled to receive data and instructions from, and transmit data and instructions to, a data storage system, at least one input device, and at least one output device. Each computer program may be implemented in a high-level procedural or object-oriented programming language or in assembly or machine language, if desired; and in any case, the language may be compiled or interpreted language. Suitable processors include, by way of example, both general and special purpose microprocessors. Generally, a processor will receive instructions and data from a read-only memory and/or a random access memory. Non-transitory storage devices suitable for tangibly embodying computer program instructions and data include all forms of computer memory including, but not limited to, non-volatile memory, including by way of example, semiconductor memory devices, such as Erasable Programmable Read-Only Memory (EPROM), Electrically Erasable Programmable Read-Only Memory (EEPROM), and flash memory devices; magnetic disks, such as internal hard disks and removable disks; magneto-optical disks; Compact Disc Read-Only Memory (CD-ROM), digital versatile disk (DVD), Blu-ray disk, universal serial bus (USB) device, memory card, or the like. Any of the foregoing may be supplemented by, or incorporated in, specially designed hardware or circuitry including, for example, application-specific integrated circuits (ASICs) and digital electronic circuitry. Thus, methods for providing image contents described above may be implemented by a program including an executable algorithm that may be executed in a computer, and the program may be stored and provided in a non-transitory computer readable medium.

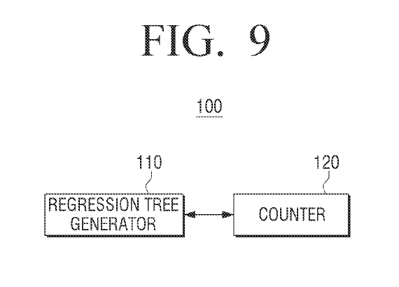

FIG. 9 is a block diagram illustrating a counting apparatus 100 according to an embodiment.

A counting apparatus according to various embodiments may be embodied as various electronic apparatuses. For example, the counting apparatus may be embodied as at least one of a closed circuit television (CCTV) camera, a digital camera, a smart phone, a server, a personal computer (PC), a tablet PC, a digital television, and a digital signage.

Referring to FIG. 9, the counting apparatus 100 according to an embodiment includes a regression tree generator 110 and a counter 120.

The regression tree generator 110 is a component for inputting information about a moving object contained in a plurality of images to generate a regression tree.

In response to a new image being input to the counter 120, the counter 120 inputs information about a moving object contained in the new input image to the regression tree to determine the number of people contained in the new image based on a result value of the regression tree.

The regression tree generator 110 identifies a movement pixel using a difference value corresponding to two or more images, and when information about the movement pixel is input from an outside, the regression tree generator 110 may classify the external input information according to a preset parameter to generate the regression tree.

Information about the movement pixel may include at least one of information about whether the movement pixel indicates a person, probability information of the movement pixel, and positional information about the movement pixel.

The regression tree generator 110 may have a node having the external input information according to a first parameter to generate the regression tree, and when external input information items of leaf nodes of the generated regression tree are not similar, the regression tree generator 110 may reconfigure the regression tree according to a second parameter different from the first parameter.

In response to a plurality of new images being input to the counter 120, the counter 120 may identify a movement pixel using a difference value between pixels corresponding to the plurality of new input images and input the information about the identified movement pixel to the regression tree.

The information about the identified movement pixel may include positional information about the identified movement pixel.

The counter 120 may determine whether the moving object contained in the new input image is a person based on the result value of the regression tree, and when the moving object is a person, the counter 120 may count the moving object when the moving object passes through a preset position on an image.

The counting apparatus 100 may further include a photograph unit (not shown) for continuously capturing the plurality of images. The photograph unit may include various technology elements for photographing an object. That is, the photograph unit may include a lens, an iris, an image processor, a storage unit, a shutter, an image sensor, and so on.

In addition, the counting apparatus 100 may include components included in a general electronic computer. That is, the counting apparatus 100 includes a hardware configuration such as a micro processing unit (MPU) or a central processing unit (CPU), a cache memory, a data bus, a storage unit, and a wired/wireless interface, and a software configuration such as an operating system and an application for specific purpose.

The foregoing example embodiments and advantages are merely example and are not to be construed as limiting. Also, the description of the example embodiments is intended to be illustrative, and not to limit the scope of the claims, and many alternatives, modifications, and variations will be apparent to those skilled in the art.

What is claimed is:

1. A counting method comprising:
generating a regression tree based at least on received information about a moving object contained in a plurality of images;
in response to a new image being received, communicating information about a moving object contained in the new image to the regression tree; and
determining the number of people contained in the new image based at least on a result value of the regression tree.

2. The counting method as claimed in claim 1, wherein the generating of the regression tree comprises:
identifying a movement pixel using a difference value between pixels corresponding to two or more images;
receiving information about the movement pixel; and
generating the regression tree by classifying the information about the movement pixel according to a preset parameter.

3. The counting method as claimed in claim 2, wherein the information about the movement pixel comprises at least one of information about whether the movement pixel indicates a person and positional information about the movement pixel.

4. The counting method as claimed in claim 2, wherein the generating of the regression tree classifying the information about the movement pixel according to the preset parameter comprises:
generating the regression tree by disposing nodes having the external input information according to a first parameter; and
reconfiguring the regression tree according to a second parameter different from the first parameter when external information items of a leaf node of the first regression tree are not similar.

5. The counting method as claimed in claim 1, wherein the communicating of the information about the moving object contained in the new image to the regression tree comprises:
in response to a plurality of new images being received, identifying a movement pixel using a difference value between pixels corresponding to the plurality of new images; and
inputting information about the identified movement pixel to the regression tree.

6. The counting method as claimed in claim 5, wherein the information about the identified movement pixel comprises positional information of the identified movement pixel.

7. The counting method as claimed in claim 1, wherein the determining of the number of the people comprises:
determining whether the moving object contained in the new image is a person based at least on the result value of the regression tree; and
when the moving object is a person, counting the people when the moving object passes through a preset position on an image.

8. The counting method as claimed in claim 1, further comprising consecutively capturing the plurality of images.

9. A counting apparatus comprising:
a regression tree generator configured to generate a regression tree using information about a moving object contained in a plurality of images; and
a counter configured, in response to a new image being received, to communicate information about a moving object contained in the new image to the regression tree and to determine the number of people contained in the new image based at least on a result value of the regression tree.

10. The counting apparatus as claimed in claim 9, wherein the regression tree generator is configured to identify a movement pixel using a difference value between pixels corresponding to two or more images and, in response to information about the movement pixel being received, generates the regression tree by classifying the information about the movement pixel according to a preset parameter.

11. The counting apparatus as claimed in claim 10, wherein the information about the movement pixel comprises at least one of information about whether the movement pixel indicates a person and positional information about the movement pixel.

12. The counting apparatus as claimed in claim 10, wherein the regression tree generator generates the regression tree by disposing nodes having the information about the movement pixel according to a first parameter and reconfigures the regression tree according to a second parameter different from the first parameter when information items of a leaf node of the first regression tree are not similar.

13. The counting apparatus as claimed in claim 9, wherein the counter, in response to a plurality of new images being received, is configured to identify a movement pixel using a difference value between pixels corresponding to the plurality of new images, and input information about the identified movement pixel to the regression tree.

14. The counting apparatus as claimed in claim 13, wherein the information about the identified movement pixel comprises positional information of the identified movement pixel.

15. The counting apparatus as claimed in claim 9, wherein the counter determines whether the moving object contained in the new image is a person based at least on the result value of the regression tree, and when the moving object is a person, the counter counts the people when the moving object passes through a preset position of an image.

16. The counting apparatus as claimed in claim 9, further comprising a photographing unit configured to consecutively capture the plurality of images.

17. A counting apparatus comprising:
regression tree generator circuitry configured to generate a regression tree using information about a moving object contained in a plurality of images; and
a counter configured, in response to a new image being received, to communicate information about a moving object contained in the new image to the regression tree and to determine the number of people contained in the new image based at least on a result value of the regression tree.

18. The counting apparatus as claimed in claim 17, wherein the counter, in response to a plurality of new images being received, is configured to identify a movement pixel using a difference value between pixels corresponding to the plurality of new images, and input information about the identified movement pixel to the regression tree.
